(19) United States
(12) Patent Application Publication
(10) Pub. No.: US 2014/0052611 A1
(43) Pub. Date: Feb. 20, 2014

(54) BRUSH HOLDER ASSEMBLY MAINTENANCE PROGRAM

(71) Applicant: Robert S. Cutsforth, Bellingham, WA (US)

(72) Inventor: Robert S. Cutsforth, Bellingham, WA (US)

(73) Assignee: CUTSFORTH, INC., Cohasset, MN (US)

(21) Appl. No.: 13/587,308

(22) Filed: Aug. 16, 2012

(51) Int. Cl. B65D 85/00; G06Q 20/22; G06F 15/00

(52) U.S. Cl. 705/39; 206/701; 702/187

(57) ABSTRACT

A method of performing maintenance of components of an electrical device including receiving a container of used brush holder assemblies at a remote location geographically removed from an electrical device facility and sending a container of unused brush holder assemblies to the electrical device facility for installation on an electrical device at the electrical device facility. The container includes a plurality of brush holder assemblies including brush holders and brushes pre-loaded in the brush holders prior to shipping the brush holder assemblies in the container. The container includes a plurality of carriers for interfacing with the brush holder assemblies. Each carrier is configured to restrict movement of the associated brush holder assembly within the container.

### TECHNICAL FIELD

The disclosure is directed to methods and associated apparatus for providing maintenance of brush holders and brushes of an electrical device at an electrical facility. More particularly, the disclosure is directed to a brush holder maintenance program for inspecting, replacing, repairing, refurbishing, exchanging, and/or disposing of brush holders, brushes, and other components of brush holder assemblies, and otherwise performing maintenance of brush holder assemblies of an electrical device.

### BACKGROUND

A purpose of a brush in an electrical device is to pass electrical current from a stationary contact to a moving contact surface, or vice versa. Brushes and brush holders may be used in electrical devices such as electrical generators, electrical motors, and/or slip ring assemblies, or sliding connection applications, for example, slip ring assemblies on a rotating machine such as a rotating crane or a linear sliding connection on a monorail. Brushes in many electrical devices are blocks or other structures made of conductive material, such as graphite, carbon graphite, electrographite, metal graphite, or the like, that are adapted for contact with a conductive surface or surfaces to pass electrical current. Electrically conductive leads or shunts extend from the brush to provide an electrical pathway to and/or from the brush from another conductive member.

In some designs, a brush box type brush holder, or other type of brush holder, may be used to support the brush during operation. The brush and brush box may be designed such that the brush can slide within the brush box to provide for continuing contact between the brush and the conductive surface contacted by the brush. Over time, the brush will be reduced in size, or get shorter (i.e., diminish in longitudinal length), for example, as the wear surface of the brush in frictional contact with the conductive surface wears down. Once a brush has worn beyond a threshold amount, a brush may need to be replaced and/or maintenance may need to be performed.

Accordingly, it is desirable to provide a means of servicing brush holder assemblies and replacing brushes, brush holders, and/or other components of a brush holder assembly.

### SUMMARY

The disclosure is directed to alternative designs, materials and methods of manufacturing electrical brush lead guide structures and assemblies, and uses thereof.

Accordingly, one illustrative embodiment is a method of performing maintenance of components of an electrical device. The method includes receiving, via a third-party parcel delivery service, a container of used brush holder assemblies at a remote location geographically removed from an electrical device facility from which the used brush holder assemblies were in service. The method also includes sending, via a third-party parcel delivery service, a container of unused brush holder assemblies to the electrical device facility for installation on an electrical device at the electrical device facility.

Another illustrative embodiment is a method of shipping a plurality of brush holder assemblies for an electrical device. The method includes placing a plurality of brush holder assemblies in a container. Each brush holder assembly includes a brush holder and a brush. In some instances, the brush may be pre-loaded in the brush holder prior to inserting the brush holder assembly in the container. The container of brush holder assemblies, with the brushes pre-loaded in the brush holders, is then sent to an electrical device facility via a third-party parcel delivery service.

Another illustrative embodiment is a method of collecting data regarding the performance of brush holder assemblies of an electrical device. The method includes receiving, via a third-party parcel delivery service, a container of used brush holder assemblies at a remote location geographically removed from an electrical device facility from which the used brush holder assemblies were in service. Thereafter, one or more components of the used brush holder assemblies are inspected, repaired, replaced, refurbished, and/or exchanged at the remote location.

Another illustrative embodiment is a method of supplying a customer with replacement brush holders and brushes of a brush holder assembly of an electrical device. The method includes accepting a fee from a customer for supplying replacement brush holder assemblies including brush holders and brushes to an electrical device at an electrical device facility. In exchange for the fee, the supplier sends replacement brush holder assemblies including brush holders and brushes to the electrical device facility via a third party parcel delivery service.

Yet another illustrative embodiment is an apparatus for shipping a plurality of brush holder assemblies. The apparatus includes a container and a plurality of brush holder assemblies packaged in the container. Each brush holder assembly includes a brush pre-loaded into a brush holder of the brush holder assembly. In some instances a plurality of carriers may be positioned in the container for interfacing with the brush holder assemblies. For example, one of the plurality of brush holder assemblies may be positioned in each of the plurality of carriers. Each carrier may be configured to restrict movement of the associated brush holder assembly within the container. For instance, each carrier may restrict movement of the respective brush relative to the corresponding brush holder positioned in the carrier.

The above summary of some example embodiments is not intended to describe each disclosed embodiment or every implementation of the aspects of the disclosure.

### BRIEF DESCRIPTION OF THE DRAWINGS

The aspects of the disclosure may be more completely understood in consideration of the following detailed description of various embodiments in connection with the accompanying drawings, in which:

FIG. 1 is a perspective view of an exemplary shipping container for shipping a plurality of brush holders and brushes from an electrical facility to a remote location for maintenance and/or from a remote location to an electrical facility to put into service on an electrical device;

FIG. 2 is a cross sectional view of the shipping container of FIG. 1;

FIG. 3 is a side view of an exemplary brush holder carrier of the shipping container of FIG. 1 with a brush holder and brush disposed therein;

FIG. 4 is a rear perspective view of an exemplary brush holder and associated brush for an electrical device;

FIG. 5 is a perspective view of the exemplary brush holder carrier of the shipping container of FIG. 1;

FIG. 6 is a top view of the brush holder carrier of FIG. 5; and

FIG. 7 is a schematic illustration of aspects of an exemplary method of performing maintenance of components, such as brushes and brush holders, of a brush holder assembly.

While the aspects of the disclosure are amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

Although some suitable dimensions, ranges and/or values pertaining to various components, features and/or specifications are disclosed, one of skill in the art, incited by the present disclosure, would understand desired dimensions, ranges and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the disclosure. The illustrative embodiments depicted are intended only as exemplary. Selected features of any illustrative embodiment may be incorporated into an additional embodiment unless clearly stated to the contrary.

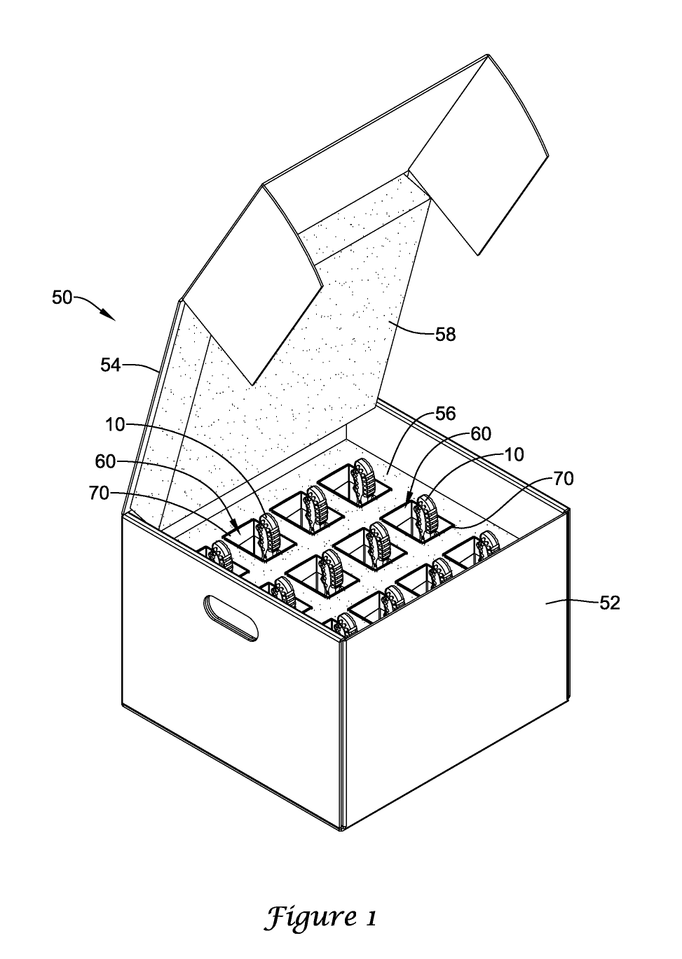

FIG. 1 illustrates an exemplary container 50 configured to transport or ship a plurality of brush holder assemblies 10, including brush holders 12, brushes 20 and other associated components. For example, the container 50 may be used to ship brush holder assemblies 10, or components thereof, to an electrical device facility (e.g., an electrical generation facility) from a remote location (e.g., a distribution and/or maintenance location) and/or to a remote location (e.g., a distribution and/or maintenance location) from an electrical device facility (e.g., an electrical generation facility). For instance, the container 50 may be used to ship unused brush holder assemblies 10, or components thereof to an electrical device facility via a third-party parcel delivery service (e.g., FedEx, UPS, U.S. Postal Service, DHL Global Mail, etc.) and/or the container 50 may be used to ship used brush holder assemblies 10, or components thereof, to a remote location via a third-party parcel delivery service (e.g., FedEx, UPS, U.S. Postal Service, DHL Global Mail, etc.) to inspect, perform maintenance on, refurbish, repair, exchange and/or replace the brush holder assemblies, or components thereof.

In some instances, a plurality of brush holder assemblies 10, a plurality of brush holders 12, a plurality of brushes 20, and/or a plurality of other components of a brush holder assembly 10 of an electrical device may be transported in the container 50 in a vehicle to and/or from the electrical device facility and/or transported in the container 50 in a vehicle to and/or from the remote location. In some instances, the vehicle may transport the container 50 to a location inside the electrical device facility (e.g., a loading bay) or the vehicle may transport the container 50 to a location outside of the electrical device facility and other means may be used to transport the container 50 or components delivered therein into the electrical device facility.

The container 50 may be of any desired construction configured to hold one or more, or a plurality of brush holder assemblies 10, or components thereof. For example, as shown in the illustrative embodiment the container 50 may include a shipping box 52 having a lid 54 configured to enclose the contents within the box 52. In some instances, the shipping box 52 and/or lid 54 may be cardboard, such as corrugated cardboard or other paper based material. In other instances, the box 52 and/or lid 54 may be formed of a polymer material or other material, if desired. The box 52 may be of any desired shape, size and construction to hold the brush holder assemblies 10. For example, the box 52 may include four sides, a bottom, and the lid 54. In some instances the lid 54 may be integrally formed with the box 52, such as hingedly attached to the box 52, whereas in other instances the lid 54 may be a separate component which may be removably placed on the box 52 to enclose the contents therein.

The container 50 may also include packaging, such as an insert 56 to secure the brush holder assemblies 10 in the container 50. The insert 56 may separate or isolate one or more brush holder assemblies 10 from one or more additional brush holder assemblies 10 to protect the brush holder assemblies 10 and secure the brush holder assemblies 10 during transport. The insert 56 may be a single block of material defining a plurality of compartments 60, or the insert 56 may be formed of a plurality of pieces of material defining a plurality of compartments 60 therebetween. In some instances, the insert 56 may be a foam insert, corrugated cardboard, or other impact absorbent material. In other embodiments, other packaging may be used to secure the brush holder assemblies 10 in the container 50 in order to protect the brush holder assemblies 10 during transport. In the illustrative embodiment, the insert 56 may include a plurality of partitions defining a plurality of compartments 60 in a two dimensional array. For example, the partitions of the insert 56 may define one or more, or a plurality of horizontal rows of compartments 60 and one or more, or a plurality of vertical columns of compartments 60. Each compartment 60 may be configured to hold one brush holder assembly 10 securely therein. However, in other embodiments, each compartment 60 may be configured to hold a plurality of brush holder assemblies 10, if desired.

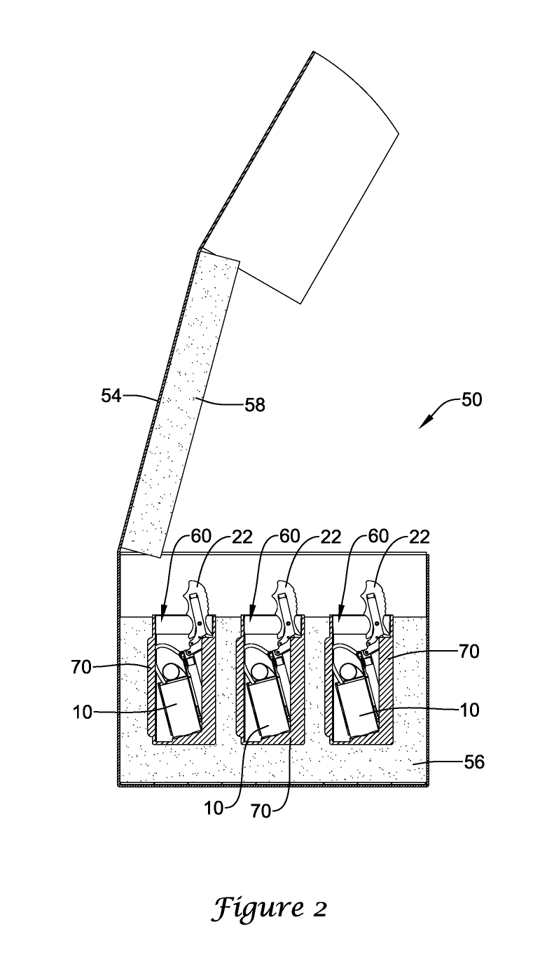

As shown in FIG. 2, the compartments 60 may be defined by four side walls and a bottom. Thus, the insert 56 may permit the brush holder assemblies 10 to be inserted and removed from the compartments 60 through an open upper opening of the compartments 60, for example. In some instances, a portion of the brush holder assembly 10, such as a portion of the handle 22, may extend above the upper surface of the insert 56.

The packaging for the container 50 may also include a cover insert 58, such as a sheet of foam or other impact absorbent material, configured to be disposed over the insert 56 to cover the upper openings of the compartments 60. For example, the cover insert 58 may be a compressible foam sheet configured to be disposed above the insert 56 such that a lower surface of the cover insert 58 faces, abuts or presses against the upper surface of the insert 56 to fully enclose the brush holder assemblies 10 in the compartments 60. For example, when the lid 54 is closed on the box 52, the cover insert 58 may press against the portion of the brush holder assemblies 10, such as the handles 22, extending above the upper surface of the insert 56 to securely retain and prevent undesirable movement of the brush holder assemblies 10 in the compartments 60 during transport. In some instances, the cover insert 58 may include indentations or recesses (not shown) to receive a portion of the brush holder assemblies 10 extending above the upper surface of the insert 56 therein. In some instances in which the cover insert 58 is formed of a compressible material, the cover insert 58 may be compressed or deformed against the portion of the brush holder assemblies 10 extending above the upper surface of the insert 56 when the lid 54 is closed and the container 50 is prepared for transport to securely retain the brush holder assemblies 10 therein. In the illustrative embodiment, the cover insert 58 may be attached to a lower surface of the lid 54, such that when the lid 54 is closed, the cover insert 58 is automatically disposed above the insert 56 to secure the brush holder assemblies 10 in the compartments 60. In other embodiments, the cover insert 58 may be manually disposed above the insert 56 prior to closing the lid 54 on the box 52.

A carrier 70 may be disposed in each of the compartments 60 of the insert 56 to receive the brush holder assemblies 10 therein. The carrier 70 may be formed of any desired material, such as a polymer material or a metal material, for example. The carriers 70 may be configured to retain the brush holder assemblies 10 in a desired stationary orientation during transport, and thus provide a stabile interface to position the brush holder assemblies 10 in the container 50. In some instances, the carriers 70 may be configured to accommodate a variety of sizes of brush holder assemblies 10. Accordingly, the carriers 70 may universally hold multiple different sizes of brush holder assemblies 10, such that a single configuration of the carrier 70 may be used regardless of the size of the brush holder assembly 10 to be disposed therein. The carrier 70 may provide a structure or housing to facilitate containment of a brush holder assembly 10 within the compartment 60 of the insert 56 to retain the brush holder assemblies 10 in a desired orientation throughout transport.

In some instances, the carrier 70 may be secured in a compartment 60 of the insert 56. For example, in some embodiments the carrier 70 may be configured to create an interference fit in the compartment 60 of the insert 56 when inserted therein. For example, the carrier 70 may be sized larger than the length and/or width of the compartment 60 such that the carrier 70 compresses or deforms the insert 56 when inserted therein. In other embodiments, the carrier 70 may be adhesively bonded, snap fit, secured with one or more fasteners, press fit, or otherwise secured in the compartment 60 of the insert 56. In other instances, the carrier 70 may be integrally formed as a portion of the insert 56. As shown in FIG. 2, a portion of the insert 56 may be positioned below the carriers 70 to provide additional protection to the brush holder assemblies 10 during transport.

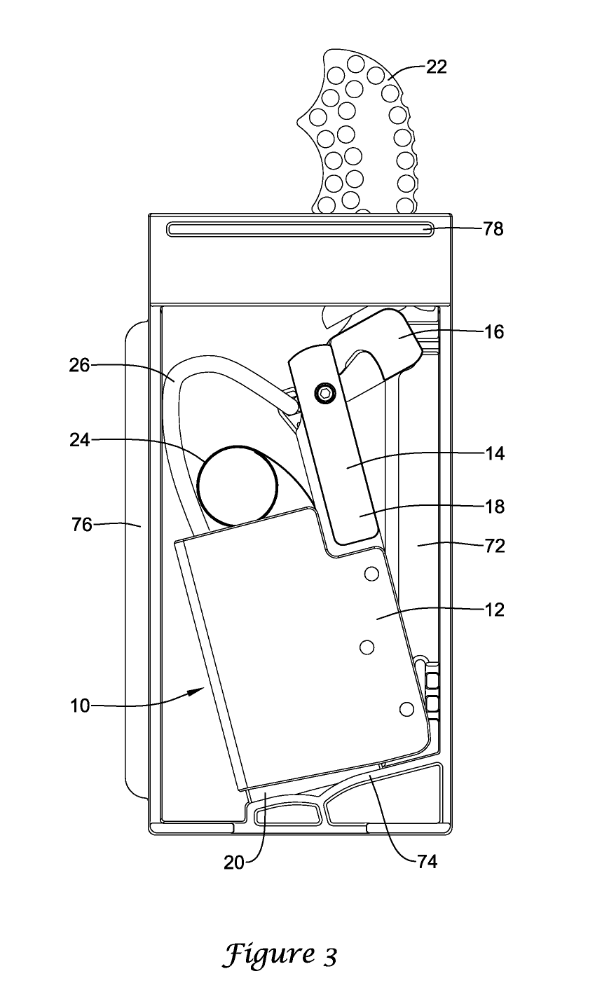

FIG. 3 is a side view of a carrier 70 with a brush holder assembly 10 disposed therein. As shown in FIG. 3, the carrier 70 may be an open box structure surrounding the brush holder assembly 10, with the handle 22 of the brush holder assembly 10 extending above the upper extent of the carrier 70, for example. The carrier 70 may interface with the brush holder 12 and/or the brush 20 of the brush holder assembly 10 to securely retain the brush holder assembly 10 therein. For example, the carrier 70 may include a securement structure, such as a rail 72, that the brush holder assembly 10 may be coupled to in order to maintain the brush holder assembly 10 in a desired stationary orientation within the carrier 70 during transport. Additionally, the carrier 70 may include a base 74, shaped to engage the brush 20 and support the brush holder assembly 10 when the brush holder assembly 10 is inserted in the carrier 70 and attached to the rail 72 or other securement structure. In some instances, the base 74 may be inclined or wedge-shaped, having a sloped or angled surface configured to rest against the brush 20 when the brush holder assembly 10 is positioned therein. The base 74 may be shaped to accommodate a variety of different sizes of brush holder assemblies 10, and thus the brush 20 may rest against the base 74 regardless of the size of the brush holder assembly 10 inserted therein.

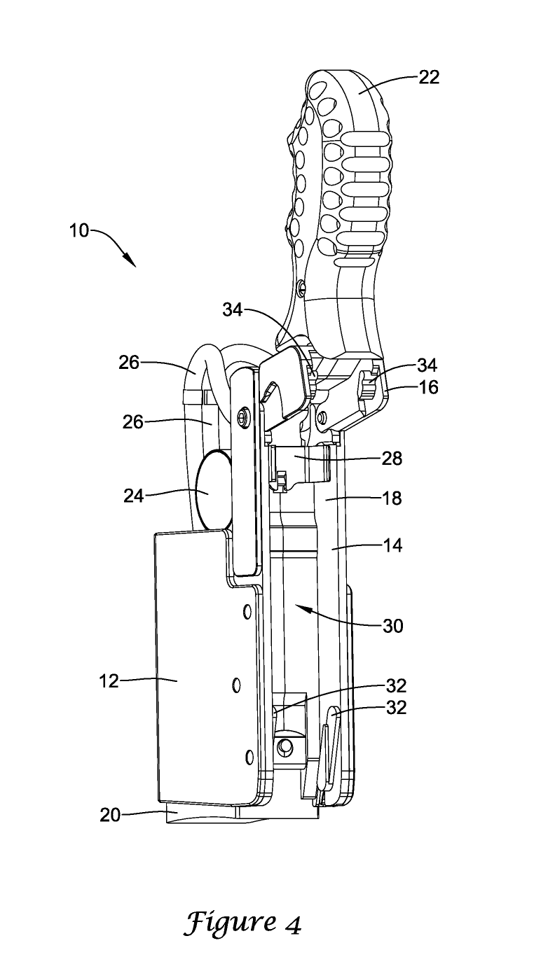

A brush holder assembly 10, for example as shown in FIG. 4, may include a brush holder 12, such as a brush box, surrounding a brush 20 on several sides and including a plurality of guiding surfaces for guiding linear or longitudinal movement of the brush 20. In some embodiments, the brush holder 12 may not take on the form of a box, but may include one or a plurality of guiding surfaces, such as channels, posts or columns, abutting and/or encompassing one or more sides of the brush 20 and/or extending into or through the brush 20, or a portion thereof, for guiding linear or longitudinal movement of the brush 20.

The brush holder 12 may be secured to a mounting beam 14 configured and adapted to be mounted to another structure, such as a mounting block of an electrical device when placed in service on the electrical device. The brush holder assembly 10 is configured to place the brush 20 in contact with a conductive surface of an electrical device, such as a rotating surface of a collector ring, a slip ring, or a commutator, and conduct current therefrom. The brush 20 may extend from the lower edge of the brush holder 12 such that a wear surface of the brush 20 may engage the conductive surface. The mounting beam 14 may include an over-center engagement mechanism, a slotted or channeled engagement mechanism for sliding engagement, or other mechanism for easily engaging and disengaging the brush 20 from a conductive surface of an electrical device.

In some embodiments, the brush holder assembly 10 may substantially resemble a brush holder assembly as described in U.S. Pat. No. 7,034,430, entitled “Brush Holder Apparatus, Brush Assembly, and Method”, which is herein incorporated by reference in its entirety. In other embodiments, the brush holder assembly may include a brush holder rigidly mounted to another structure holding the brush holder stationary, or mounted to another structure in any desired arrangement. For example, in some embodiments the brush holder may be bolted or welded to a stationary structure. Some such brush holders are disclosed in U.S. Pat. Nos. 6,731,042; 5,753,992; 5,621,262; 5,463,264; 5,397,952; and 5,256,925; which are incorporated herein by reference.

As shown in FIG. 4, the mounting beam 14 may include an upper beam member 16 and a lower beam member 18 hingedly or pivotably coupled to one another. As shown in FIG. 4, when the upper beam member 16 is tilted from the lower beam member 18 (e.g., the longitudinal axis of the upper beam member 16 is oblique to the longitudinal axis of the lower beam member 18), the brush holder 12 may be considered to be in a disengaged, or unlocked, position such that the brush 20 may be non-contiguous with, spaced from, or otherwise not in direct electrical contact with the conductive surface of the electrical device for removal from and/or assembly to an electrical device. When the upper beam member 16 and the lower beam member 18 are aligned with one another (e.g., the longitudinal axis of the upper beam member 16 is parallel with the longitudinal axis of the lower beam member 18), the brush holder 12 may be considered to be in an engaged, or locked position, such that the brush 20 may be contiguous with or in contact with the conductive surface of the electrical device while in use. The mounting beam 14 may be removably coupled to the mounting block of the electrical device during operation by actuating the upper beam member 16 relative to the lower beam member 18 between the unlocked, disengaged position and the locked, engaged position.

The mounting beam 14 may be configured to mate with the rail 72 or other securement structure of the carrier 70 to couple the brush holder assembly 10 in a secured stationary orientation within the carrier 70 with the brush 20 resting against the base 74, for example. In some instances, the rail 72 may be constructed similar to the mounting block of an electrical device, such that the mounting beam 14 may be similarly coupled to the rail 72. As shown in FIG. 3, in some embodiments the mounting beam 14 may be coupled to the rail 72 with the brush holder assembly 10 in the unlocked position in which the upper beam member 16 is obliquely oriented relative to the lower beam member 18.

The mounting beam 14, such as the lower beam member 18 and/or the upper beam member 16, may define a channel 30 for receiving the rail 72, or other securement structure therein. For example, the channel 30 may be defined between opposing side surfaces of the lower beam member 18 and/or the upper beam member 16 and a rear side of the lower beam member 18 and/or the upper beam member 16 from which the side surfaces extend from. In some instances, the mounting beam 14 may be slidably coupled to the rail 72 by slidably disposing the rail 72 in the channel 30. The mounting beam 14 may include engagement features, such as projections 32 extending into the channel 30 from opposing side surfaces of the lower beam member 18 configured to engage with engagement features of the carrier 70, such as engagement features of the rail 72. Additionally or alternatively, the mounting beam 14 may include engagement features, such as projections 34 extending into the channel 30 from opposing side surfaces of the upper beam member 16 configured to engage with engagement features of the carrier 70.

In some embodiments, a handle 22 may be attached to the brush holder 12 to facilitate engagement and disengagement of the brush 20 from the electrical device. For example, the handle 22 may be attached to the upper beam member 16 such that movement of the handle 22 actuates (e.g., pivots, slides, releases) the upper beam member 16 relative to the lower beam member 18 between the disengaged position and the engaged position. The handle 22 may be a removable handle or the handle 22 may be permanently attached to the upper beam member 16 or another portion of the brush holder 12.

Also illustrated in FIG. 4 is a brush spring 24, such as a constant force spring, which provides tension to the brush 20 to bias the brush 20 toward and in contact with the conductive surface of the electrical device. The spring 24 may be attached to a portion of the brush holder 12 or the mounting beam 14 of the brush holder assembly 10, for example. In some embodiments, the spring 24 may extend along one side surface of the brush 20 between the brush 20 and the mounting beam 14 of the brush holder assembly 10.

The brush 20 may include one or more electrical leads (e.g., shunts) 26, such as braided copper cables, for conducting electricity to and/or from the electrically conductive surface of the electrical device through the brush 20. For example, first and second electrical leads 26 may extend from the brush 20 to an electrically conductive terminal 28 coupled to a component of the brush holder assembly 10, such as the mounting beam 14. The ends of the leads 26 may be soldered, brazed, crimped, clamped or otherwise removably or permanently secured to the terminal 28.

The brush holder assembly 10 may also include a brush lead guide (not shown) configured to retain the leads 26 extending from the brush 20 in a desired position/orientation to ensure the leads 26 do not interfere with movement of the brush 20 within the brush holder 12. In some embodiments, the brush lead guide may substantially resemble a brush lead guide as described in U.S. patent application Ser. No. 13/419,937 filed on Mar. 14, 2012, entitled “Brush Lead Guide for a Brush Holder Assembly”, which is herein incorporated by reference in its entirety. For example, the guide may maintain the first lead 26 and the second lead 26 in a spaced apart arrangement such that the spring 24 may be positioned between the first lead 26 and the second lead 26. In some instances, a brush wear marker may be incorporated with the brush lead guide, or a separate brush wear marker may be provided with the brush holder assembly 10 to provide an indication of the extent of wear of the brush 20 during use.

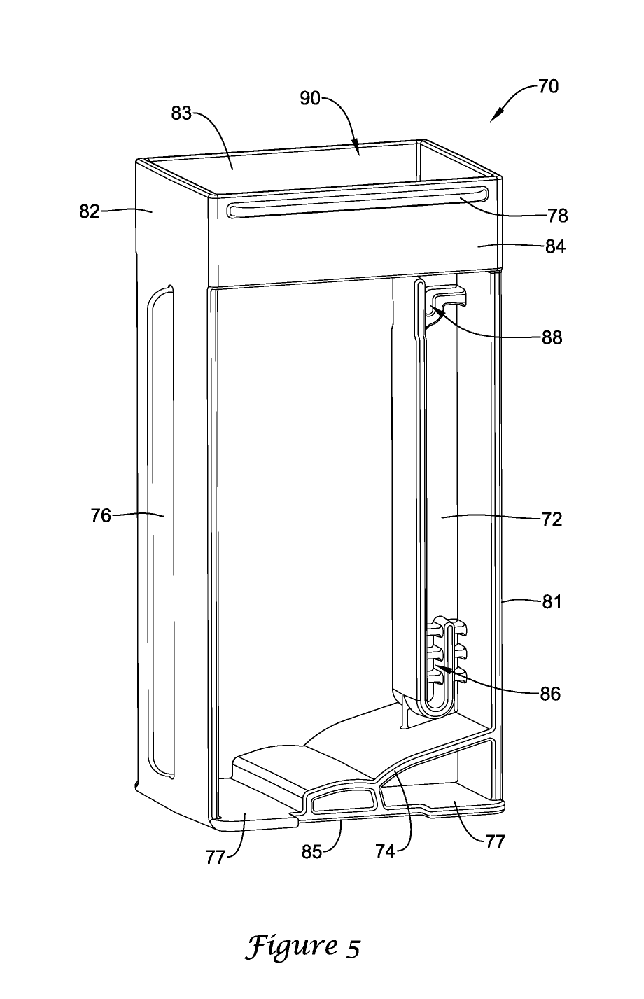

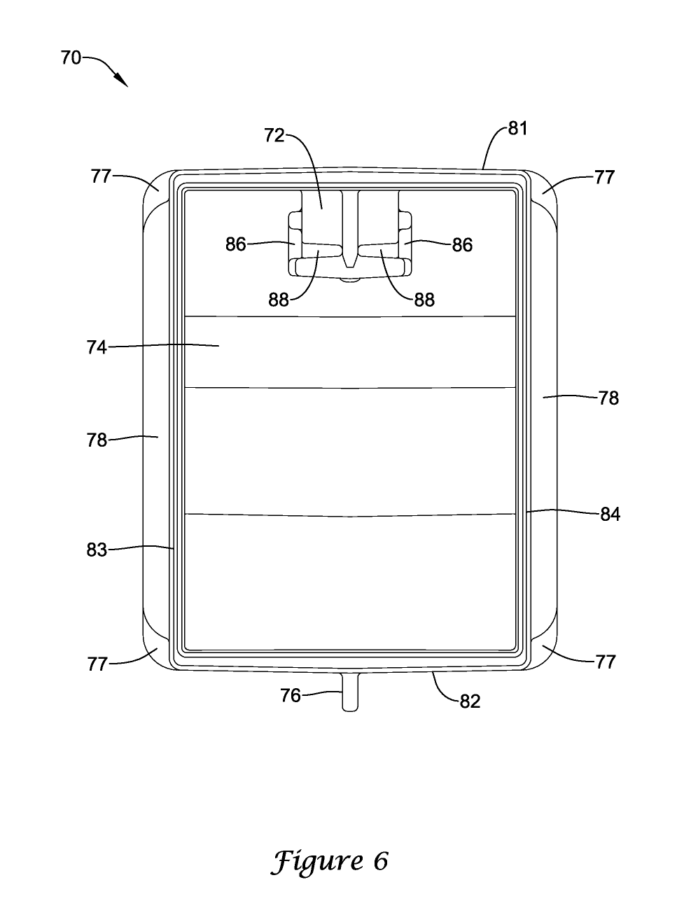

Aspects of the illustrative embodiment of the carrier 70 are further illustrated in FIGS. 5 and 6. As shown in the illustrative embodiment, in some instances the carrier 70 may be configured as an open framework, having a rear wall 81, a front wall 82, side walls 83, 84 extending between the rear wall 81 and front wall 82, a base 85, and an opening upper end 90 opening into the interior of the carrier 70. The rail 72, or other securement structure, may extend into the interior of the carrier 70 from the rear wall 81.

The carrier 70 may also include one or more, or a plurality of retention features to facilitate securement of the carrier 70 in a compartment 60 of the insert 56. For instance, the carrier 70 may include one or more, or a plurality of extensions extending outward from one or more of the sides of the carrier 70 to provide further securement of the carrier 70 in a compartment 60. For example, the carrier 70 may include one or more, or a plurality of extensions 77 extending outward from the base wall 85 configured to engage with the insert 56. Additionally or alternatively, the carrier 70 may include one or more, or a plurality of extensions 78 extending outward from the side walls 83, 84 and/or the carrier 70 may include one or more, or a plurality of extensions 76 extending outward from the rear wall 81 and/or front wall 82.

The rail 72 may be configured to engage with the brush holder assembly 10 in order to secure the brush holder assembly 10 in a stationary orientation within the carrier 70. In the illustrative embodiment, the rail 72 may be spaced equidistantly between the side walls 83, 84 such that the brush holder assembly 10 is centered between and spaced from the side walls 83, 84 when disposed in the carrier 70. For example, the mounting beam 14 may be slidably disposed over the rail 72, as the brush holder assembly 10 is inserted into the carrier 70 through the upper open end 90 to center the brush holder assembly 10 between the side walls 83, 84.

The rail 72 may be shaped and configured to interlock with the engagement features of the mounting beam 14, for example. For instance, the rail 72 may include channels 86 defined on opposing sides of the rail 72 configured to slidably receive the projections 32 of the lower beam member 18 therein when the rail 72 is slidably disposed in the channel 30 of the mounting beam 14. Furthermore, the rail 72 may include channels 88 defined on opposing sides of the rail 72 configured to slidably receive the projections 34 of the upper beam member 16 therein when the rail 72 is slidably disposed in the channel 30 of the mounting beam 14. Engagement of the projections 32, 34 in the channels 86, 88, respectively, may secure the brush holder assembly 10 to the rail 72 within the carrier 70 to stabilize the brush holder assembly 10 in the container 50 during transport.

The brush holder assemblies 10 may be transported in the container 50 with the brushes 20 disposed (e.g. pre-assembled or pre-loaded) in the brush holder 12 of the brush holder assembly 10. The carrier 70 may be configured to restrict movement of the brush 20 disposed in the brush holder 12 of the brush holder assembly 10. For example, the carrier 70 may be configured to contact at least a portion of the brush holder 12 to restrict movement of the brush holder 12 relative to the carrier 70, and the carrier 70 may be configured to contact at least a portion of the brush 20 (positioned in the brush holder 12) to restrict movement of the brush 20 relative to the carrier 70 and the corresponding brush holder 12. For example, the rail 72 may engage or contact the brush holder 12 to restrict movement of the brush holder 12 relative to the carrier 70 while the base 74 may engage or contact the brush 20 to restrict movement of the brush 20 relative to the carrier 70 and the brush holder 12. The base 74 may additionally contact the lower surface of the brush 20 to counter the biasing force of the spring 24 pressing against the upper surface of the brush 20 with the brush 20 installed in the brush holder 12. Thus, the interaction of the base 74 of the carrier 70 with the brush 20 and the rail 72 of the carrier 70 with the mounting beam 14 of the brush holder 12 may cooperatively retain the brush 20 in the brush holder 12 during transportation of the brush holder assembly 10. Thus, the brush 20 may be retained in the brush holder 12 by means other than the brush catch of the brush holder assembly 10, described in U.S. Pat. No. 7,034,430, entitled “Brush Holder Apparatus, Brush Assembly, and Method”, which is herein incorporated by reference in its entirety. For example, a separate component, such as the carrier 70, that must be removed from the brush holder assembly 10 prior to installing the brush holder assembly 10 on an electrical device may be used to retain the brush 20 in the brush holder 12 during transportation in the container 50.

The container 50 may be configured to transport or ship a plurality of brush holder assemblies 10, including brush holders 12, brushes 20 and other associated components without damaging the brush holder assemblies 10. For example, the container 50 may be configured to transport or ship a plurality of brush holder assemblies 10 via a third-party parcel delivery service as a part of a maintenance program.

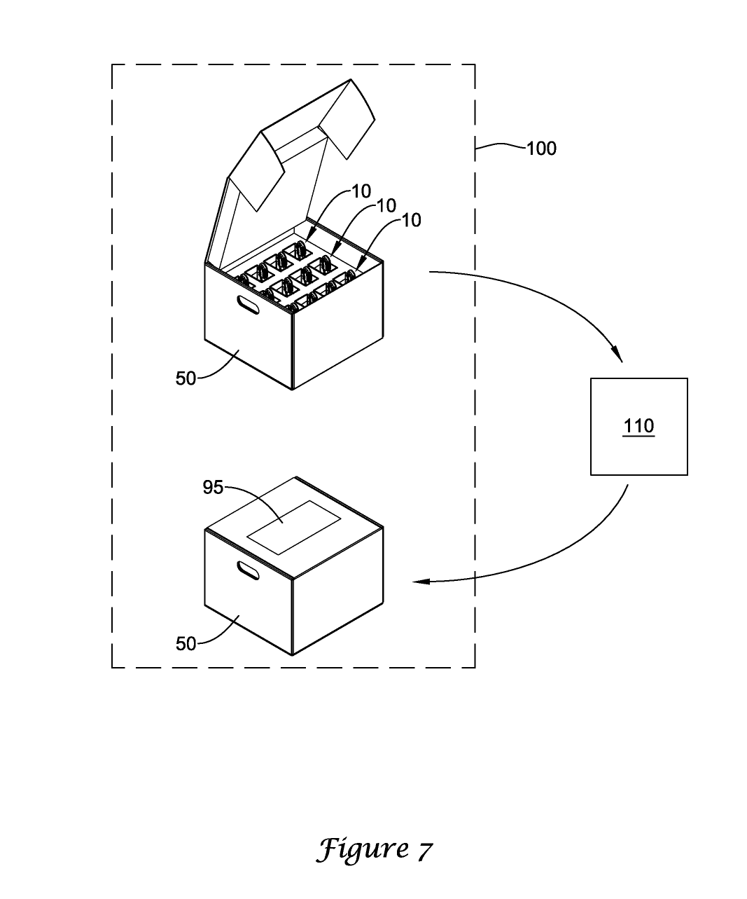

FIG. 7 is a schematic illustration of aspects of an exemplary method of performing maintenance of components, such as brushes 20 and brush holders 12, of a brush holder assembly 10 in which the container 50 may be used to ship brush holder assemblies 10, or components thereof, to an electrical device facility 100 (e.g., an electrical generation facility) from a remote location 110 (e.g., a distribution and/or maintenance location) and/or to a remote location 110 (e.g., a distribution and/or maintenance location) from an electrical device facility 100 (e.g., an electrical generation facility). In some instances, the remote location 110 may be considered a maintenance, distribution and/or data collection facility. In describing the remote location 110, what is meant is a site geographically distant of the electrical device facility 100 requiring transport of the container 50 via one or more transportation channels (e.g., trucks, airplanes, trains, boats, or other vehicles) through commerce to ship the container to/from the electrical device facility 100 via a third-party parcel delivery service. In some instances, the remote location 110 may send/receive containers 50 of used brush holder assemblies 10 from a plurality of electrical device facilities 100 geographically remote from one another such that the remote location 110 may be common to the plurality of electrical device facilities 100. Thus, although the following description of an exemplary method of performing maintenance of brush holder assemblies 10 at an electrical device facility 100, is described in association with a single electrical device facility 100, it is noted that similar methods may be implemented for additional electrical device facilities 100 in a similar manner.

An electrical device facility 100, having one or more, or a plurality of brush holder assemblies 10 mounted on an electrical device, such as an electrical generator may be provided with a container 50 filled with unused brush holder assemblies 10 ready to be put into service on the electrical device (e.g., with brushes 20 pre-installed or pre-loaded in the brush holders 12). In describing the brush holder assemblies 10 as being unused, what is meant is that the brush holder assemblies 10 are in a working condition ready to be installed on the electrical device, in which previously worn components from any previous usage on an electrical device (such as used brushes 20, springs 24, leads 26, terminals 28, and other replaceable components) have been replaced with new components, as needed, to prepare the brush holder assembly 10 for being put into service. It is noted that the brush holder 12, including the mounting beam 14 and handle 22, may be reused on the electrical device numerous times, upon replacing the worn components, such as the brush 20, spring 24, leads 26 and/or terminal 28.

As a brush 20 of a brush holder assembly 10 wears down beyond a threshold condition, or other condition arises in which it is determined to replace a brush holder assembly 10 on the electrical device with an unused brush holder assembly 10, personnel at the electrical device facility may remove the used brush holder assembly 10 from the electrical device and install an unused brush holder assembly 10 (removed from the container 50) in its place on the electrical device. Thus, the personnel may exchange the used brush holder assembly 10 with the unused brush holder assembly 10, removing the used brush holder assembly 10 from the electrical device and placing the used brush holder assembly 10 in the container 50 while removing the unused brush holder assembly 10 from the container 50 and installing the unused brush holder assembly 10 on the electrical device. This process may be periodically repeated by personnel at the electrical device facility 100 until all of the unused brush holder assemblies 10 in the container 50 have been put into service at the electrical facility and the container 50 is filled with used brush holder assemblies 10.

The container 50, full of used brush holder assemblies 10, may then be transported (e.g., shipped) to the remote location 110 such as via a third-party parcel delivery service. For example, personnel at the electrical facility 100 may secure the brush holder assemblies 10 in the container 50 by closing the lid 54, and securing the lid 54 on the box 52 for shipment. The container 50 may include a shipping label 95 provided with the container by the remote location 110 or placed on the container 50 at the electrical device facility 100 to direct the container through transportation channels to the remote location 110. In some instances, shipping charges may be prepaid by the remote location 110.

The container 50, full of used brush holder assemblies 10, may be received at the remote location 110. Upon arrival at the remote location 110, or at another designated time before or after receiving the first container 50, a second container 50 full of unused brush holder assemblies 10 may be transported (e.g., shipped) to the electrical device facility 100 from the remote location 110, or another location prescribed by or controlled by the remote location 110, such as via a third-party parcel delivery service. Thus, in some instances, multiple containers 50 may be used to transport brush holder assemblies 10 to/from the electrical device facility 100. In other instances, the used brush holder assemblies 10 in the first container 50 may be replaced with unused brush holder assemblies 10 and then the first container 50 may be transported or shipped back to the electrical facility 100, thus utilizing a single container 50.

When received at the remote location 110, one or more tasks, processes, and/or responsibilities may be performed by personnel at the remote location 110. For example, personnel at the remote location 110 may check the used brush holder assemblies 10, or components thereof, for signs of abnormal wear, overheating (e.g., discolored leads), or check components (e.g. terminals 28) for signs of poor electrical connections (e.g., pitting or discoloration). Personnel at the remote location 110 may inspect components of the brush holder assemblies 10, such as inspect the dimensional integrity of the brush holder 12, inspect the brush holder 12 for restrictions (e.g., carbon deposits, dings, burrs, or other foreign material), inspect the brush catch for proper functionality (e.g., pressure, cleanliness, and dimensional integrity), inspect components (e.g., the brush holder 12) for cracks, breaks, missing or damaged parts, inspect the hinge and catch arm of the mounting beam 14 for functionality and lubricate if needed. Reusable components of the brush holder assembly 10, such as the brush holder 12, may be cleaned to remove any carbon residue or other foreign material. For example, personnel may thermally and/or ultrasonically clean the brush holders 12, and other reusable components. If needed, the interior of the brush holder 12, in sliding contact with the brush 20, may be resurfaced or polished prior to installing a new brush 20 in the brush holder 12.

Once all the reusable components have been inspected, cleaned, refurbished, etc., the brush holder assembly 10 may be reassembled with new wear components (e.g., brush 20, brush spring 24, leads 26, terminal 28, and/or brush lead guide, if applicable). For example, a new brush 20 may be pre-installed or pre-loaded in the brush holder 12 and the terminal 28, attached to the leads 26 extending from the brush 20, may be coupled to the mounting beam 14 of the brush holder 12. A new spring 24 and/or brush lead guide, if needed, may be installed in the brush holder assembly 10 when the brush 20 is installed. The brushes 20 and associated components may be pre-installed or pre-loaded into the brush holders 12 prior to or subsequent to inserting the brush holders 12 into the container 50, such that the container 50 filled with unused brush holder assemblies 10 may be subsequently sent to the electrical device facility 100 with the brushes 20 pre-installed or pre-loaded in the brush holders 12. It is also noted that personnel at the remote location 110 may recycle all worn or used components of the brush holder assemblies 10.

Additional services may also be performed at the remote location 110. For example, personnel at the remote location 110 may record maintenance data of the brush holder assemblies 10, such as procedures performed, findings, and/or replacement of components of brush holder assemblies 10 on a customer web portal, or other database accessible to personnel at the electrical device facility 100 or other monitoring facility for the electrical device facility 100. Thus, the remote location 110 may provide customer results of how the electrical device units at the electrical device facility 100 are performing, including a comparison of how the electrical device units at the electrical facility 100 are performing relative to industry averages, devices at other electrical facilities, or other comparative data. The remote location may also provide data of how an electrical device at an electrical device facility 100 is performing individually, based on empirical, historical or previously collected records, which may provide an indication of whether the electrical device at the electrical device facility 100 is experiencing problems, or whether maintenance may need to be performed on the electrical device. In some instances, collected data may be restricted such that different levels of access to the data are granted to individuals and/or entities, as desired. Collected data may be made available by any desired means, such as electronic means, including email, a web page, a web portal, etc.

Personnel at the electrical device facility 100 may monitor the brushes 20 of the brush holder assemblies 10 installed or in service on the electrical devices, such as monitor for brush wear, and change brushes 20 of a brush holder assembly 10 as needed. Additionally or alternatively, personnel at the electrical device facility 100 may monitor for discoloration of the leads 26 or other components and any arcing of components of the brush holder assembly 10, and inform personnel at the remote location 110 of any such discoloration or arcing, if needed.

Personnel at the electrical device facility 100 may also periodically record vibrations of the brushes 20 of brush holder assemblies 10 using a vibration probe. For instance, personnel may position a vibration probe against a brush 20 and collect data regarding the vibration of the brush 20 for a duration of time with the vibration probe. The personnel may then periodically (e.g., daily, weekly, monthly) record or upload the collected data to a website, a web portal or other database. In some instances, the collected data of vibrations of the brushes 20 or other data may be recorded or saved on a data storage device, such as a digital data storage device (e.g., a USB flash drive, a memory card, memory stick, CD, DVD, or other digital media storage device). The recorded vibrations may be recorded and stored directly to the data storage device from the vibration probe, or the collected data may be subsequently transferred to the data storage device.

The data storage device, having the collected data recorded and stored on the data storage device, may be sent to personnel at the remote location 110. For example, the data storage device may be shipped by a third party parcel service in the container 50 of used brush holder assemblies 10 or in a separate package. The data saved on the data storage device may then be inputted to a database from the remote location 110.

Personnel at the remote location 110 may evaluate the collected data and/or compare the collected data with other data collected. Thus, a comparative analysis of the collected data may be performed to further evaluate the condition of the electrical device and/or to evaluate the performance of the electrical device to other electrical devices. In some instances, collected data may be restricted such that different levels of access to the data are granted to individuals and/or entities, as desired. Collected data may be made available by any desired means, such as electronic means, including email, a web page, a web portal, etc.

Personnel at the remote location 110 may replace the used brush holder assemblies from the container 50 with unused brush holder assemblies at the remote location. For instance, personnel may prepare unused brush holder assemblies at the remote location by replacing worn components of the used brush holder assemblies. The prepared unused brush holder assemblies may then be packaged in a container 50 (e.g., the container returned from the electrical device facility or another container) with new brushes 20 pre-loaded in brush holders 12 of the unused brush holder assemblies 10. At a designated time, the container 50 of unused brush holder assemblies 10 may be shipped back to the electrical device facility 100, or to another electrical device facility, to replace used brush holder assemblies 10 taken out of service.

In some instances, one or more, or a plurality of containers may be associated with each electrical device facility. For example, a first container and a second container may be used to ship brush holder assemblies to/from the electrical device facility 100 from/to the remote location 110. The first container may be located at the electrical device facility 100. Once the first container 50 is filled with used brush holder assemblies 10, the first container 50 may be shipped to the remote location 110 and the second container 50, filled with unused brush holder assemblies 10, may be shipped to the electrical device facility 100 from the remote location 110. The timing of the shipment of unused brush holder assemblies 10 to the electrical device facility 100 may be controlled as desired. For example, the second container 50 of unused brush holder assemblies 10 may be shipped from the remote location 110 upon notification of shipment of the first container 50 to the remote location 110, upon receiving the first container 50 at the remote location 110, based on a pre-established schedule, or other designated time, as desired.

In some instances, such a brush holder assembly maintenance program may provide a means for personnel at the remote location (e.g., maintenance and/or distribution facility) to connect with customers (e.g., personnel at the electrical device facilities), while facilitating the regular or periodic collection of data to aid in understanding specifics of brush wear. For example, data from multiple electrical device facilities may be collected and uploaded to a database of a common data collection portal for evaluation and/or analysis. In some instances, collected data may be restricted such that different levels of access to the data are granted to individuals and/or entities, as desired. Collected data may be made available by any desired means, such as electronic means, including email, a web page, a web portal, etc.

Furthermore, the collection of used brush holder assemblies from multiple electrical device facilities at a common maintenance/distribution location remote from the electrical device facilities may consolidate resources and reduce expenses related to performing maintenance of the electrical devices. For example, maintenance personnel from or affiliated with the remote location 110 may not need to go to the electrical device facility 100 to perform maintenance of the electrical device and/or brush holder assemblies 10, which may reduce costs incurred by the electrical device facility 100.

The customer (e.g., the electrical device facility 100) and the supplier (e.g., the remote location 110) may enter into a business agreement where the supplier provides replacement brush holder assemblies 10, or components thereof (e.g., brush holders 12, brushes 20, etc.) in exchange for a fee. For example, the supplier may accept a fee from the customer for supplying replacement brush holder assemblies 10 including brush holders 12 and brushes 20 to an electrical device at an electrical device facility. In exchange for the fee, replacement (e.g., unused) brush holder assemblies 10 including brush holders 12 and brushes 20 may be sent from the supplier to the electrical device facility via a third party parcel delivery service. In some instances the fee associated with supplying the replacement brush holder assemblies may be a one time fee, or the fee may be a periodically recurring fee (e.g., weekly, monthly, quarterly, semi-annually, annually, etc.) In some instances, the fee associated with supplying and sending replacement brush holder assemblies may be included in the cost of purchasing replacement brushes from the supplier. In some instances, the agreement may require the customer to send used components (e.g., used brush holder assemblies 10, used brush holders 12, worn brushes 20, etc.) to the supplier. In some instances, sending replacement brush holder assemblies 10 from the supplier occurs upon notice of used brush holder assemblies 10 being sent to the supplier. In some instances, the customer must provide the supplier with proof that replacement of brushes 20 is warranted prior to sending replacement brush holder assemblies 10. In some instances, sending replacement brush holder assemblies 10 is at the discretion of the supplier upon inspection of brush holder assemblies 10 in service at the electrical device facility.

Those skilled in the art will recognize that aspects of the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A method of performing maintenance of components of an electrical device, comprising:
receiving, via a third-party parcel delivery service, a container of used brush holder assemblies at a remote location geographically removed from an electrical device facility from which the used brush holder assemblies were in service; and
sending, via a third-party parcel delivery service, a container of unused brush holder assemblies to the electrical device facility for installation on an electrical device at the electrical device facility.

2. The method of claim 1, further comprising:
preparing unused brush holder assemblies at the remote location by replacing worn components of the used brush holder assemblies.

3. The method of claim 2, further comprising:
packaging the prepared unused brush holder assemblies in a container with new brushes pre-loaded in brush holders of the unused brush holder assemblies.

4. The method of claim 1, further comprising:
replacing the used brush holder assemblies with unused brush holder assemblies at the remote location.

5. The method of claim 1, wherein the container received from the electrical device facility and the container sent are different containers.

6. The method of claim 1, wherein the container received from the electrical device facility and the container sent are the same container.

7. The method of claim 1, further comprising:
inspecting one or more components of the used brush holder assemblies at the remote location.

8. The method of claim 1, further comprising:
collecting data regarding the state or condition of one or more components of the used brush holder assemblies;
inputting the collected data into a database; and
analyzing the collected data.

9. The method of claim 1, wherein the container of used brush holder assemblies includes brush holders with brushes installed therein, and the container of unused brush holder assemblies includes brush holders with brushes installed therein.

10. A method of shipping a plurality of brush holder assemblies for an electrical device, comprising:
placing a plurality of brush holder assemblies in a container, wherein each brush holder assembly includes a brush holder and a brush; and
sending the container of brush holder assemblies with the brushes pre-loaded in the brush holders to an electrical device facility via a third-party parcel delivery service.

11. The method of claim 10, further comprising:
engaging each brush holder assembly with a carrier in the container, wherein each carrier restricts movement of the associated brush holder assembly within the container.

12. The method of claim 11, wherein the carriers are configured to restrict movement of the respective brush relative to the corresponding brush holder.

13. The method of claim 11, further comprising:
for each brush, brush holder and respective carrier:
engaging the brush holder to the carrier to restrict movement of the brush holder relative to the carrier; and
contacting the brush positioned in the brush holder with the carrier to restrict movement of the brush relative to the brush holder.

14. The method of claim 11, wherein the carriers are shaped to accommodate a variety of different sizes of brush holder assemblies.

15. A method of collecting data regarding the performance of brush holder assemblies of an electrical device, the method comprising:
receiving, via a third-party parcel delivery service, a container of used brush holder assemblies at a remote location geographically removed from an electrical device facility from which the used brush holder assemblies were in service; and
inspecting one or more components of the used brush holder assemblies at the remote location.

16. The method of claim 15, further comprising:
collecting data regarding the state or condition of the one or more components of the used brush holder assemblies.

17. The method of claim 16, further comprising:
inputting the collected data into a database.

18. The method of claim 17, further comprising:
analyzing the collected data.

19. The method of claim 18, wherein analyzing the collected data includes comparing the collected data to data collected from one or more other electrical device facilities.

20. An apparatus for shipping a plurality of brush holder assemblies, the apparatus comprising:
a container; and
a plurality of brush holder assemblies packaged in the container, wherein each brush holder assembly includes a brush pre-loaded into a brush holder of the brush holder assembly.

21. The apparatus of claim 20, further comprising:
a plurality of carriers positioned in the container;
wherein the plurality of brush holder assemblies are positioned in two or more of the plurality of carriers.

22. The apparatus of claim 21, wherein each carrier restricts movement of the associated brush holder assembly within the container.

23. The apparatus of claim 22, wherein each carrier restricts movement of the respective brush relative to the corresponding brush holder positioned in the carrier.

24. The apparatus of claim 23, wherein each brush holder assembly includes a mounting beam engaged with a rail of the carrier within which the brush holder assembly is positioned.

25. The apparatus of claim 21, wherein the plurality of carriers are arranged in an array within the container.

26. The apparatus of claim 25, wherein the container includes an insert separating each of the carriers within the container.

27. The apparatus of claim 20, further comprising:
an insert positioned in the container, the insert defining one or more compartments;
wherein at least one of the brush holder assemblies is positioned in the one or more compartments.

28. A method of supplying a customer with replacement brush holders and brushes of a brush holder assembly of an electrical device, comprising:
accepting a fee from a customer for supplying replacement brush holder assemblies including brush holders and brushes to an electrical device at an electrical device facility; and
sending replacement brush holder assemblies including brush holders and brushes from a supplier to the electrical device facility via a third party parcel delivery service.

29. The method of claim 28, wherein the fee is a periodically recurring fee.

30. The method of claim 28, wherein the fee is included in a cost of replacement brushes charged to the customer.

31. The method of claim 28, wherein sending replacement brush holder assemblies occurs upon notice of used brush holder assemblies being sent to the supplier.

32. The method of claim 28, further comprising:
providing to the supplier with proof that replacement of brushes is warranted prior to sending replacement brush holder assemblies.

33. The method of claim 28, wherein the step of sending replacement brush holder assemblies is at the discretion of the supplier upon inspection of brush holder assemblies in service at the electrical device facility.
